(19) United States
(12) Patent Application Publication
(10) Pub. No.: US 2008/0054990 A1
(43) Pub. Date: Mar. 6, 2008

(54) Charge pump method and architecture

(75) Inventors: Hau-Tai Shieh, Hsinchu City (TW); Chen-Hui Hsieh, Chu-Pei City (TW); Chung-Cheng Chou, Hsin-Chu (TW)

Correspondence Address: L. Howard Chen, Esq.;Kirkpatrick & Lockhart Preston Gates Ellis LLP, Suite 1700, 55 Second Street, San Francisco, CA, 94104, US

(73) Assignee: Taiwan Semiconductor Manufacturing Co., Ltd.

(21) Appl. No.: 11/512,514

(22) Filed: Aug. 30, 2006

(51) Int. Cl. G05F 1/10

(52) U.S. Cl. 327/536

(57) ABSTRACT

A method for operating a plurality of charge pumps comprising: generating one or more phase-shifted clock signals; and coupling the one or more phased-shifted clock signals to the plurality of charge pumps, wherein the charge pumps are clocked at a different time to avoid excessive charging spikes caused by concurrent operation of the charge pumps.

### BACKGROUND

The present invention relates generally to charge pumps, and more particularly to a system and method for operating charge pumps to minimize the effect of the charging spikes.

Charge pumps provide a way for designers to provide differing voltages based on a single power supply voltage. For example, if a circuit requires a negative 5 volt power supply and only a positive 5 volt power supply is available, a charge pump may be used to provide to the negative 5 volt power supply from a positive 5 volt power supply (a voltage inverter). Besides a voltage inverter, charge pumps may be configured to provide differing voltages. For example, a change pump may be configured to provide a voltage twice the amplitude of the input voltage (a voltage doubler). Charge pumps are often used in memory circuits, especially for Flash memory where multiple voltages are required to properly read from and write to the memory cells.

Charge pump voltage converters use the storage property of capacitors to store energy. If a capacitor is charged to a predetermined voltage, removed from a circuit and then reconnected in the opposite polarity, the voltage on the capacitor will be the inverse of the original predetermined voltage. In essence, capacitive voltage conversion is achieved by charging and switching a capacitor periodically such that sufficient charge is transferred to meet the power requirements of the circuit under consideration.

The rate of charging and switching the capacitor is typically governed by a clock signal. A clock signal generally has a first part and a second part out of phase with each other by 180 degrees such that for a portion of a clock cycle the signal is “on” or represented by a logical ‘1’ and for a portion of the clock cycle, the signal is “off” or represented by a logical ‘0’. The two portions of the clock signal are usually referred to as the first half and the second half of the signal, although the first and second portions may not be of equal duration. Usually, the first half of the clock signal is used to control circuitry that charges the capacitor. The second half of the clock signal is used to control circuitry that will switch the capacitor such that a different polarity is applied to a circuit. Different circuitry using clock signals to charge and switch a capacitor are known in the art. For example, passive diodes can be used in the simplest of cases. Passive diodes provide the advantage of being simple solid state devices that are easy to implement monolithically. More advanced charge pumps may use transistors, thyristors, mechanical switches or other devices to achieve the same result.

When the capacitor is charged, current rushes into to the capacitor for a short while causing an instant “charging spike” in the current. The size of these charging spikes is proportional to the amount of current supplied by the charge pump. When multiple charge pumps are used, the charging spikes are also a function of how many charge pumps are charging at the same time.

If multiple charge pumps are used, and the charge spikes all occur at or near the same time, there may be a significant power spike from the demand of all the charge pumps being charged at the same time. As such, what is needed is a circuit that operates the charge pumps at differing clock times so that the charging spikes are minimized.

### SUMMARY

The current disclosure provides a method for operating a plurality of charge pumps comprising: generating one or more phase-shifted clock signals, and coupling the one or more phased-shifted clock signals to the plurality of charge pumps, wherein the charge pumps are clocked at a different time to avoid excessive charging spikes caused by concurrent operation of the charge pumps.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates a simplified schematic of a conventional charge pump.

FIG. 2 illustrates one embodiment of the current invention using a single oscillator.

FIG. 3 illustrates another embodiment of the current invention using a multiphase oscillator.

FIG. 4 illustrates exemplary waveforms and resulting current for an embodiment of the present invention.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

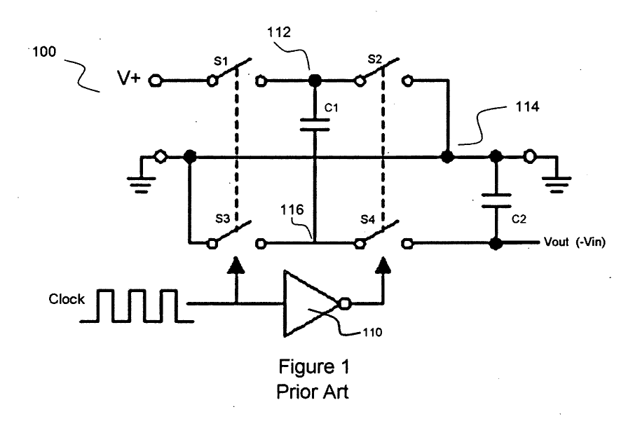

FIG. 1 shows a simplified schematic diagram of a conventional charge pump. In this circuit, a main clock signal having a first half cycle and a second half cycle is applied to an inverter 110. In the circuit shown, the clock signal alternates between a logical ‘1’ state in the first half cycle and a logical ‘0’ state in the second half cycle. For the current embodiment the first half cycle and the second half cycle may be of differing durations. The alternating clock signal is applied to inverter 110 to generate its inverse. The clock cycle and its inverse are used to drive a series of switches such that a charge storage device is charged to a predetermined voltage, removed from the circuit and then reconnected in the opposite polarity across a reservoir capacitor connected across the output. In the circuit shown, switches S1 and S3 are closed during the first half of the clock cycle to apply the voltage V+ to the storage device capacitor C1 connected from node 112 to node 116. Also during the first half of the clock cycle, switches S2 and 54 are open, isolating a second capacitor C2 and the output (Vout) from C1.

During the second half of the clock cycle, switches S2 and S4 are closed and switches S1 and S3 are opened. Closing switches S2 and S4 provides a means for the charges stored in capacitor C1 to be transferred to the reservoir capacitor C2. In this circuit, the charges on capacitor C1 are applied to capacitor C2 in such a manner as to invert the voltage polarity by transferring the charges at the positive node 112 to the grounded terminal of C2 at node 114 and transferring the charges at node 116 to capacitor C2 such that Vout is the opposite voltage of V+.

For the example shown, the circuit has no output regulation, and the switching frequency remains constant for all loads. Thus, the output-voltage variation depends strongly on the load. With no load, the output voltage corresponds to the negative input voltage: VOUT=−(V+). As the load increases, VOUT decreases.

In this circuit, when switches S1 and S2 close, the current is drawn from the main power supply V+ to charge capacitor C1. This inrush of the current to C1 causes a spike in the demand for the current that the main power supply at V+ must provide.

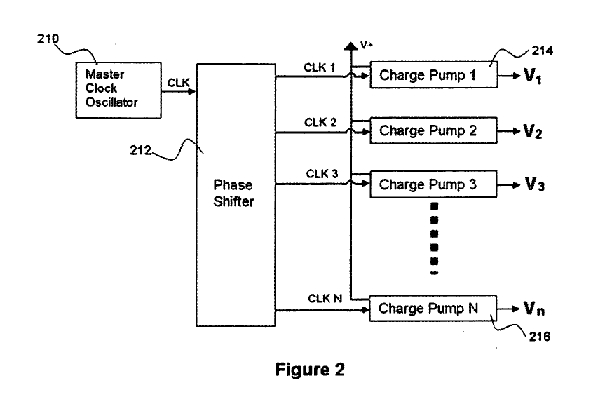

FIG. 2 shows one embodiment of the current invention. In this embodiment, a single clock signal is applied to a phase shifter such that a plurality of phase shifted clock signals are generated. In this embodiment, the phase shifter can be any circuit that causes a time delay such that the resulting phase shifted signal would transition from one state to another at a different time than the master clock signal. The plurality of phased shifted clock signals are applied to a plurality of charge pumps whereby the time when each charge pump draws its maximum current is different such that the maximum current demand (the charging spike) on the main power supply (V+) is less than it would be if all the charge pumps create a charging spike concurrently.

To practice the invention according to the current disclosure, a single master clock signal CLK is connected to a phase shifter 212. The phase shifter 212 generates a plurality of phase-shifted clock signals CLK 1-CLK N, which in turn are connected to a plurality of charge pumps. In this embodiment, CLK 1 may be in phase with the master clock signal. Each charge pump generates an output voltage V1-Vn based on the clock signal received from the phase shifter and the main power supply voltage V+.

The phase shifter 212 can be constructed using a variety of conventional circuits known in art. These circuits may use a resistive and capacitive means to shift the phase of the master clock signal CLK, however phase shifts may be generated by other means such as switching delays. Once the phase is shifted, the signal may be cleaned up and buffered to provide an appropriate output for the following stages. The phase shift circuits can be cascaded to provide multiple phase-shifted signals to the charge pumps CLK 1 through CLK N. Since no two clock signals transition at the same time, each charge pump will be clocked at a different time and will reach its maximum current draw (the charge spike) from the main power supply V+ at a different time, in effect minimizing the instantaneous peak current draw on the power supply compared to operating all the charge pumps concurrently.

One having skill in the art will recognize that this embodiment can be realized regardless of the output voltage of each charge pump and the load attached to the output of each charge pump. References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

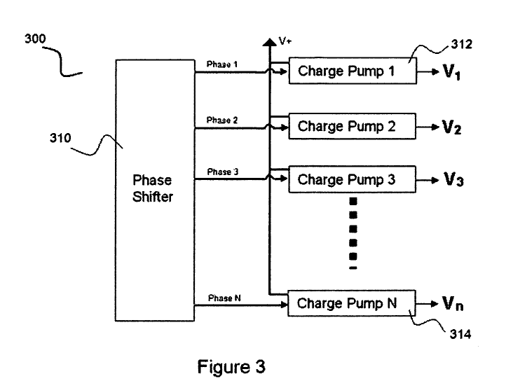

FIG. 3 shows another embodiment of the present invention using a multi-phase oscillator 310. The multi-phase oscillator 310 can be constructed of many different circuits known in the art. One form of the multiphase oscillator is known as a ring oscillator. Typically a ring oscillator is a circuit composed of an odd number of inverters. The inverters are attached in a chain; the output of the last inverter is fed back into the input of the first. Since the last output of a chain of an odd number of inverters is the logical inverse of the first input, every inverter in the “ring” of inverters will be triggered in a continuous fashion. The output from each of the inverters has a small time delay from its input. Circuit designers can use the output of each stage of a ring oscillator to provide a plurality of phase-shifted clock signals, phase 1 through phase N.

The outputs of the multi-phase oscillators (Phase 1 through N) are connected to a plurality of charge pumps such that the operation of the charge pump is controlled by the phase signal. Since no two clock signals will transition at the same time, each charge pump will reach its maximum current draw from the main power supply V+ at a different time, in effect minimizing the instantaneous peak's current draw on the power supply, compared to operating all the charge pumps concurrently.

One having skill in the art would be expected to realize this embodiment using a variety of phase shifted oscillators and charge pumps known in the art.

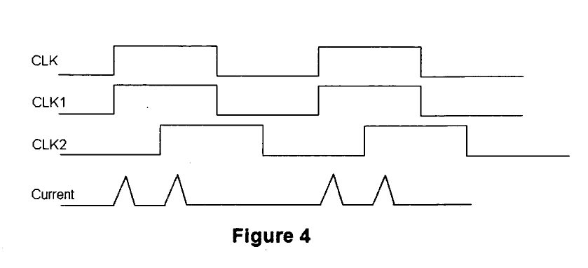

FIG. 4 is an exemplary timing diagram illustrating how an embodiment of the invention may appear. FIG. 4 shows the master clock signal CLK, the outputs of the phase shifter CLK1 and CLK2 and the resulting current spike in relation to the clock cycles. FIG. 4 shows charging spikes occurring at different times such that compared to a circuit where all the charge pumps are switched on at the same time, the peak amount of current required from the main supply voltage is minimized. Also, in circuits where charge pumps are controlled by separate clock signals, this disclosure is beneficial because the charge pumps operate in tandem, whereas separate clock signals may occur coincident.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for operating a plurality of charge pumps comprising:
generating one or more phase-shifted clock signals; and
coupling the one or more phased-shifted clock signals to the plurality of charge pumps,
wherein the charge pumps are clocked at a different time to avoid excessive charging spikes caused by concurrent operation of the charge pumps.

2. The method of claim 1 further comprising:
receiving a master clock signal,
wherein the one or more phase-shifted clock signals are generated based on the master clock signal.

3. The method of claim 1, wherein the one or more phase-shifted clock signals are out of phase with each other.

4. The method of claim 3, wherein each of the one or more phase-shifted clock signals is connected to a separate charge pump.

5. A power control circuit comprising:
a phase shift circuit for receiving a master clock signal and generating a plurality of phase-shifted output signals; and
a plurality of charge pumps for receiving the one or more phase-shifted output signals,
wherein the plurality of charge pumps are clocked at a different time to avoid excessive charging spikes caused by concurrent operation of the charge pumps.

6. The power control circuit of claim 5, wherein each phase-shifted output signal is out of phase with each other phased-shifted output signal.

7. The power control circuit of claim 6, wherein each charge pump is connected to a separate phase-shifted output signal whereby the charge pumps do not draw peak current at the same time.

8. A method of operating a plurality of charge pumps comprising:
generating one or more phase-shifted clock signals wherein each of the one or more phase-shifted clock signals is out of phase with the other phase-shifted clock signals; and
coupling the phased-shifted clock signals to the plurality of charge pumps,
wherein the plurality of charge pumps are clocked at different times.

9. The method of claim 8, wherein each of the phase-shifted clock signals is connected to a separate charge pump.

10. The method of claim 9 further comprising:
receiving a master clock signal,
wherein each of the one or more phase-shifted clock signals is generated based on the master clock signal.

11. The method of claim 9, wherein the one or more phase-shifted clock signals are generated from a ring oscillator.
